(19) United States
(12) Patent Application Publication
(10) Pub. No.: US 2020/0160412 A1
(43) Pub. Date: May 21, 2020

(54) SERVER DEVICE AND INFORMATION PROVIDING METHOD

(71) Applicant: TOYOTA JIDOSHA KABUSHIKI KAISHA, Toyota-shi (JP)

(72) Inventors: Ryota OSUMI, Toyota-shi (JP); Hiroyuki NAKAJIMA, Toyota-shi (JP); Daijiro MORIWAKI, Toyota-shi (JP); Toshiomi YAMADA, Toyota-shi (JP)

(73) Assignee: TOYOTA JIDOSHA KABUSHIKI KAISHA, Toyota-shi (JP)

(21) Appl. No.: 16/592,197

(22) Filed: Oct. 3, 2019

(30) Foreign Application Priority Data
Nov. 16, 2018 (JP) 2018-215942

(51) Int. Cl. G06Q 30/02

(52) U.S. Cl. CPC G06Q 30/0283

(57) ABSTRACT

In a first server device, a first acquirer acquires identification information of a target vehicle. A second acquirer acquires vehicle information of the target vehicle including date and time information and maintenance information of the target vehicle including date and time information based on the identification information that has been acquired. A second derivation unit derives information to be provided, based on the vehicle information and the maintenance information that have been acquired. A provider provides the information to be provided that has been derived.

The disclosure of Japanese Patent Application No. 2018-215942 filed on Nov. 16, 2018 including the specification, drawings and abstract is incorporated herein by reference in its entirety.

### BACKGROUND

### 1. Technical Field

The present disclosure relates to a server device and an information providing method for providing information used for the assessment of vehicles.

### 2. Description of Related Art

JP 2015-64616 discloses a vehicle assessment support device that specifies the standard price of an assessment target vehicle, calculates an added value or a reduced value specific to the assessment target vehicle with respect to the standard price based on actual vehicle status information showing the status of the actual vehicle, and calculates the assessed value of the assessment target vehicle based on the standard price and the added value or the reduced value.

According to the technique of JP 2015-64616, the assessed value is calculated without taking into consideration information that is difficult to obtain through the external appearance check and/or inspection of the vehicle such as how the vehicle has been maintained. Therefore, even if the vehicle has been carefully maintained and is in good condition, this information may not be reflected in the assessed value.

### SUMMARY

In this background, a purpose of the present embodiment is to provide a server device and information providing method capable of providing highly accurate information to be provided in which the maintenance status of a vehicle is reflected.

A server device according to one embodiment of the present embodiments includes: a first acquirer configured to acquire identification information of a target vehicle; a second acquirer configured to acquire vehicle information of the target vehicle including date and time information and maintenance information of the target vehicle including date and time information based on the identification information that has been acquired; a derivation unit configured to derive information to be provided, based on the vehicle information and the maintenance information that have been acquired; and a provider configured to provide the information to be provided that has been derived.

According to this embodiment, a highly accurate information to be provided in which the maintenance status of the vehicle is reflected.

The maintenance information may include replacement date and time information of a part or oil. The derivation unit may derive the information to be provided, based on the replacement date and time information and predetermined recommended replacement time.

The maintenance information may include replacement date and time information of a part. The derivation unit may derive the information to be provided, based on vehicle information obtained after replacement date and time related to a replaced part of the target vehicle.

Another embodiment relates to an information providing method. This method includes: acquiring identification information of a target vehicle; acquiring vehicle information of the target vehicle including date and time information and maintenance information of the target vehicle including date and time information based on the identification information that has been acquired in the acquiring of the identification information; deriving information to be provided, based on the vehicle information and the maintenance information that have been acquired in the acquiring of the vehicle information and the maintenance information; and providing the information to be provided that has been derived in the deriving.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing the configuration of an information processing system according to the first embodiment;

FIG. 2 is a diagram showing the flow of data in the information processing system of FIG. 1;

FIG. 3 is a block diagram illustrating the configuration of a first server device of FIG. 1;

FIG. 4 is a diagram showing a display example of a vehicle record of a vehicle whose vehicle type is a hybrid that is generated by the first server device of FIG. 1;

FIG. 5 is a diagram showing a display example of a vehicle record of a vehicle whose vehicle type is a gasoline vehicle that is generated by the first server device of FIG. 1;

FIG. 6 is a diagram showing a display example of a vehicle record of a vehicle whose vehicle type is an electric vehicle (EV) or fuel cell vehicle (FCV) that is generated by the first server device of FIG. 1;

FIG. 7 is a flowchart showing the process of the first server device of FIG. 1;

FIG. 8 is a diagram showing the flow of data in an information processing system according to the fourth embodiment;

FIG. 9 is a diagram showing the flow of data in an information processing system according to the sixth embodiment; and

FIG. 10 is a diagram showing the flow of data in an information processing system according to the eighth embodiment.

### DETAILED DESCRIPTION

Various embodiments now will be described. The embodiments are illustrative and are not intended to be limiting.

### First Embodiment

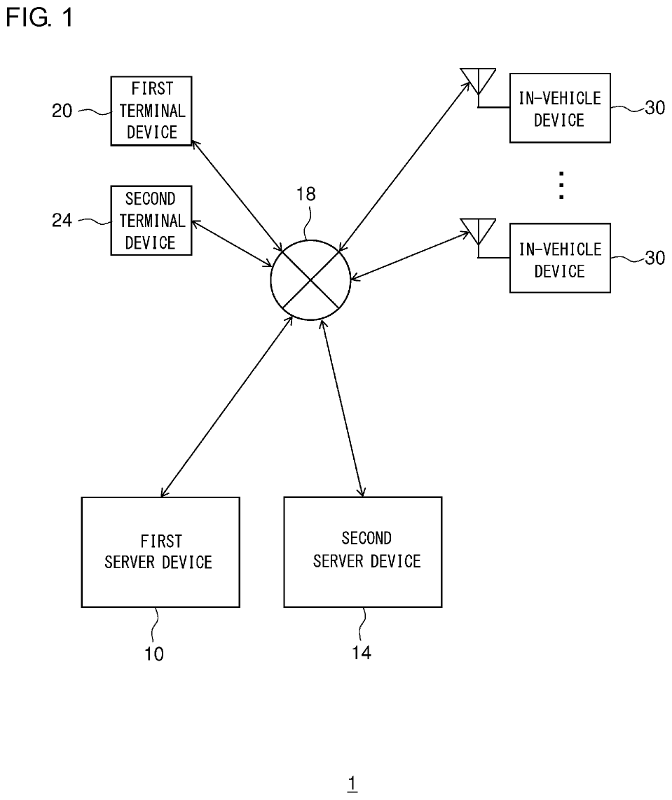

FIG. 1 shows the configuration of an information processing system 1 according to the first embodiment. The information processing system 1 is a used car transaction support system that supports transactions when the vehicle is traded as a used car, using history information of the vehicle collected from the vehicle, and is specifically used for the assessment of the vehicle.

The information processing system 1 includes a first server device 10, a second server device 14, a first terminal device 20, a second terminal device 24, and a plurality of in-vehicle devices 30.

The in-vehicle devices 30 have a wireless communication function and connect to a network 18 via a wireless base station or a wireless access point (not shown). The second server device 14, the first terminal device 20, and the second terminal device 24 each connect to the network 18 by wired communication or wireless communication. The first server device 10 is connected to the network 18, and the first server device 10 can communicate with the second server device 14, the first terminal device 20, the second terminal device 24, and the in-vehicle devices 30 via the network 18.

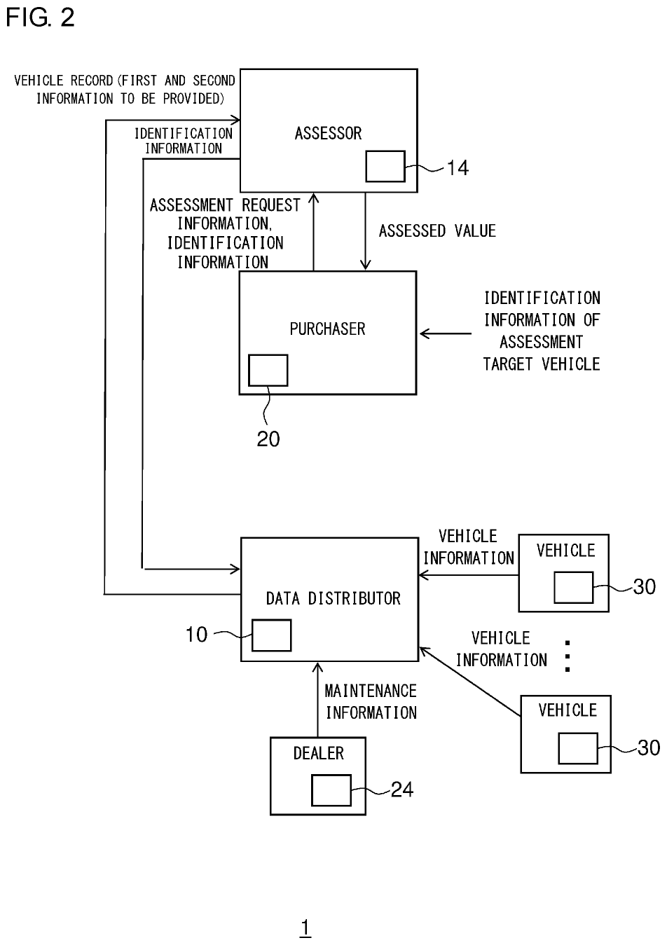

FIG. 2 shows the flow of data in the information processing system 1 of FIG. 1. The first server device 10 is provided at a data center of a data distributor. The data distributor may be a car manufacturer. The second server device 14 is managed by a vehicle inspection specialized company, a remaining value calculation company, or the like that serves as a vehicle price assessor.

The first terminal device 20 is used by a car purchaser such as a second-hand vehicle purchaser, a vehicle dealer, a leasing company, a car rental company, etc. The purchaser purchases vehicles from users.

The second terminal device 24 is provided at a facility that performs maintenance and repair of a vehicle such as a dealer, a maintenance facility, or the like. An in-vehicle device 30 is mounted on a vehicle that is a motor vehicle.

Although illustration is omitted, there are a plurality of assessors, purchasers, and dealers, and a plurality of second server devices 14, first terminal devices 20, and second terminal devices 24 can be provided.

The in-vehicle device 30 periodically acquires vehicle information of the own vehicle and periodically transmits the vehicle information to the first server device 10. The date and time of the acquisition are attached to the vehicle information. The vehicle information is also referred to as CAN data and includes information such as, for example, speed, longitudinal acceleration, lateral acceleration, deceleration, accelerator operation amount, brake operation amount, steering angle, fuel consumption amount per unit time, eco mode selection state, odometer value, safety equipment operational information, various sensor values of the engine, and various sensor values for a driving battery (lithium ion secondary battery). The eco mode represents a fuel efficiency-oriented mode where the vehicle runs while the engine revolution speed is kept lower than that in a standard mode.

The in-vehicle device 30 transmits information regarding an abnormality of an in-vehicle system detected by a failure diagnosis device (not shown) of the own vehicle to the first server device 10 as vehicle diagnostic information. The vehicle diagnostic information is also included in the vehicle information. This function is referred to as a remote diagnosis function. The abnormality of the in-vehicle system includes, for example, burning out of various lamps, failure of various sensors, etc., and when an abnormality of the in-vehicle system occurs, a warning lamp of the vehicle is lighted up.

The frequency of acquiring the vehicle information can be appropriately determined through an experiment or the like and may be, for example, once in a few minutes. The frequency of transmitting the vehicle information can be appropriately determined through an experiment or the like and may be, for example, the same as the frequency of acquiring the vehicle information. Identification information for identifying the vehicle is attached to the vehicle information that is transmitted. The identification information is, for example, a vehicle identification number (VIN).

When maintenance of the vehicle is performed at a dealer or the like, the second terminal device 24 receives an input of maintenance information of the vehicle from an employee or the like and transmits the maintenance information that has been received to the first server device 10. The maintenance information includes replacement information and replacement date and time information of parts such as a battery, a lamp, and an oil filter replaced due to the maintenance of the vehicle, and replacement information and replacement date and time information of oil such as an engine oil and a brake fluid, and the like. The identification information of the vehicle is attached to the maintenance information.

When a used car is sold to a new owner at a dealer, a used car seller, or the like, the first terminal device 20 or the second terminal device 24 receives an input of owner change information of the vehicle from an employee or the like and transmits the owner change information that has been received to the first server device 10. The owner change information includes the attribute of the owner indicating an individual or a corporation, information on owner change time, and the like. The identification information of the vehicle is attached to the owner change information.

When purchasing a vehicle, a purchaser obtains declaration information from the original owner of the vehicle that includes information indicating whether there is an accident history, a flood history, or a disregarded recall, and the like. The first terminal device 20 transmits the declaration information of the vehicle to the first server device 10. The identification information of the vehicle is attached to the declaration information.

These pieces of information: the vehicle information; the maintenance information; the owner change information; and the declaration information, are generically referred to as history information. The vehicle information and the maintenance information are considered to be associated based on date and time information.

The first server device 10 of the data distributor periodically acquires the history information of a plurality of vehicles from the respective in-vehicle devices 30 of the plurality of vehicles or the like and accumulates for each vehicle the history information that has been acquired. The first server device 10 stores the history information in association with identification information. The first server device 10 collects history information for each vehicle continuously from when the vehicle is sold as a new car to when the vehicle is scrapped.

Using the history information accumulated in this manner, the first server device 10 provides the assessor with the vehicle record of the assessment target vehicle. The flow of data at this time will be described below.

The purchaser obtains the identification information of the assessment target vehicle after obtaining consent to obtain the history information for assessment from the vehicle owner who wishes to sell the vehicle. The first terminal device 20 of the purchaser transmits assessment request information and the acquired identification information of the assessment target vehicle to the second server device 14 of the assessor. The assessment request information includes an image of the external appearance of the assessment target vehicle, and the like. For example, the purchaser inputs necessary items on the screen of the assessor's assessment system displayed on the first terminal device 20 so as to request assessment.

The second server device 14 of the assessor acquires the assessment request information and the identification information and transmits the acquired identification information to the first server device 10.

The first server device 10 acquires the history information of the assessment target vehicle from the database based on the acquired identification information and generates a vehicle record of the assessment target vehicle based on the acquired history information. The first server device 10 provides the vehicle record that has been generated to the second server device 14.

The vehicle record includes, for example, the driving tendency of the past driver of the vehicle, the evaluation on the engine, the evaluation on the driving battery, the maintenance status, the failure history, the accident history, information indicating whether there was one owner or not. The driving tendency indicates how the assessment target vehicle has been driven and is information that is difficult to grasp through the external appearance check and/or inspection of the assessment target vehicle. The details of the vehicle record will be described later.

The second server device 14 of the assessor derives an assessed value based on the vehicle record of the assessment target vehicle and provides the assessed value that has been derived to the first terminal device 20 of the purchaser.

For example, the second server device 14 calculates a provisional assessed value based on a known technology in light of a vehicle classification, a model year, a travel distance, an image of an external appearance, etc. The second server device 14 calculates the assessed value to be cheaper than the provisional assessed value in case of a rough-driving tendency based on the vehicle record and calculates the assessed value to be higher than the provisional assessed value in case of a moderate-driving tendency. An employee of the assessor may check the vehicle record and calculate the assessed value.

Based on the vehicle record, the assessor can calculate a more appropriate assessed value and provide the assessed value to the purchaser. Since the assessed value is determined in consideration of the internal aspect of the vehicle in addition to the external appearance of the vehicle, the assessed value of a vehicle, whose assessed value would be lower otherwise due to the external appearance such as color and the like in assessment without the vehicle record, is likely to become higher as long as the internal aspect is good. The purchaser can easily obtain the assessed value simply by providing the assessor with the identification information. The user of the vehicle has an advantage that the assessed value is likely to become high as long as the user rides the vehicle with care.

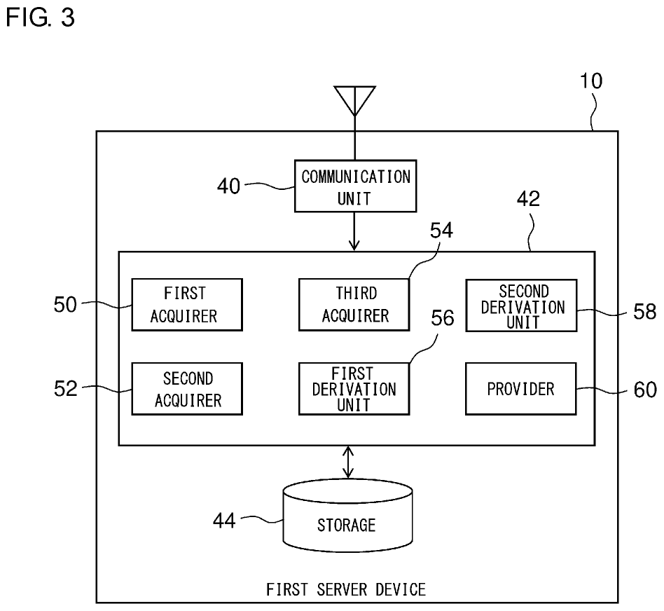

FIG. 3 is a block diagram showing the configuration of the first server device 10 of FIG. 1. The first server device 10 includes a communication unit 40, a processor 42, and a storage 44. The processor 42 includes a first acquirer 50, a second acquirer 52, a third acquirer 54, a first derivation unit 56, a second derivation unit 58, and a provider 60.

The configuration of the processor 42 is implemented in hardware by any CPU of a computer, memory or other LSI's, and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only, software only, or the combination of both.

The communication unit 40 communicates with the plurality of in-vehicle devices 30, the second server device 14, etc. The communication unit 40 periodically receives the history information of a plurality of vehicles from the plurality of in-vehicle devices 30 or the like and outputs the received history information of the plurality of vehicles to the third acquirer 54.

The third acquirer 54 acquires the history information of the plurality of vehicles received by the communication unit 40 and stores the acquired history information of the plurality of vehicles in the storage 44 in association with identification information.

The first derivation unit 56 periodically derives statistical information on the history information of the plurality of vehicles for each vehicle classification and stores the derived statistical information in the storage 44. The statistical information includes, for example, an average value of evaluation values of respective characteristics such as engine torque and output, an average value of evaluation values of driving tendency, an average value of fuel efficiency, a maximum value of fuel efficiency, and the like.

The first derivation unit 56 may derive statistical information with regard to each vehicle classification for each model year and may further derive statistical information with regard to each model year for each travel distance classification.

The communication unit 40 receives the identification information of the assessment target vehicle from the second server device 14 and outputs the received identification information to the first acquirer 50. The first acquirer 50 acquires the identification information of the assessment target vehicle that has been received by the communication unit 40.

Based on the identification information acquired by the first acquirer 50, the second acquirer 52 acquires, from the storage 44, the history information of the assessment target vehicle and the statistical information regarding the vehicle classification of the assessment target vehicle.

Based on the identification information acquired by the first acquirer 50 and the history information and the statistical information acquired by the second acquirer 52, the second derivation unit 58 derives the vehicle record of the assessment target vehicle. The vehicle record is composed of first information to be provided and second information to be provided. The first information to be provided is information regarding the assessment target vehicle in the vehicle record. The second information to be provided is information regarding the statistical value of the vehicle classification of the assessment target vehicle in the vehicle record.

The second derivation unit 58 derives the first information to be provided based on the identification information and the history information and derives the second information to be provided based on the statistical information regarding the vehicle classification of the assessment target vehicle.

The second derivation unit 58 identifies the vehicle classification, the model, the model year, the vehicle equipment, and the acquired items of the vehicle information based on the identification information that has been acquired. The second derivation unit 58 derives the first information to be provided, based on the vehicle classification, the model, the model year, the vehicle equipment, and the acquired items of the vehicle information that have been identified and on history information. The first information to be provided includes a vehicle classification, a model, a model year, vehicle equipment, a travel distance, an accident history, a flood history, disregarded recall, evaluation on engine, evaluation on driving battery, fuel efficiency, a travel frequency, a single travel distance, a driving tendency of the past driver of the vehicle, a warning lamp lighting history, a maintenance history, etc. The vehicle equipment may include optional equipment and may include a navigation system, a back guide monitor, safety equipment, and the like. The safety equipment may include, for example, an anti-lock brake system (ABS), a lane keeping assist (LKA), an automatic brake, and the like.

Further, for example, in the case of a vehicle that has passed 15 years since the vehicle was sold as a new car, the period for the vehicle information used to derive the vehicle record may be different as in a vehicle record based on vehicle information for the last five years and a vehicle record based on vehicle information for the entire 15 years. For the maintenance information, the owner change information, and the declaration information, information for the entire period is preferably used. When deriving a vehicle record based on vehicle information for a predetermined period in the immediate past, the processor 42 may delete vehicle information older than that for the predetermined period from the storage 44. Thereby, the amount of data that is stored can be reduced.

The period for the vehicle information to be used may vary depending on information to be derived. For example, the driving tendency may be derived based on the vehicle information for the entire period, and the fuel efficiency may be derived based on the vehicle information for a predetermined period such as the last few months.

The provider 60 provides the first information to be provided and the second information to be provided that have been derived by the second derivation unit 58 to the second server device 14 of the assessor via the communication unit 40. The subsequent process performed in the second server device 14 is as described above.

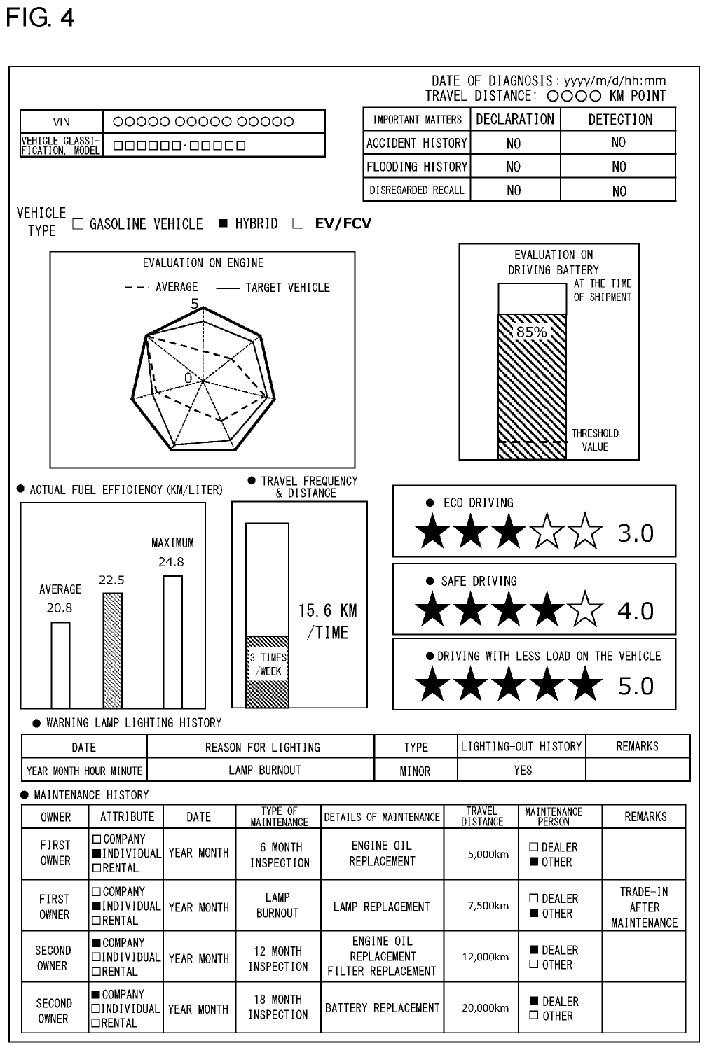

FIG. 4 shows a display example of a vehicle record of a vehicle whose vehicle type is a hybrid that is generated by the first server device 10 of FIG. 1. The vehicle record includes a vehicle classification, a travel distance, an accident history, a flood history, disregarded recall, evaluation on engine, evaluation on driving battery, fuel efficiency, a travel frequency, a single travel distance, a driving tendency of the past driver of the vehicle, a warning lamp lighting history, and a maintenance history.

The accident history, the flood history, and the disregarded recall each includes the presence or absence of a declaration by the past owner of the vehicle and the presence or absence of the detection of an accident history, a flood history, or disregarded recall based on the vehicle information or the maintenance information. The second derivation unit 58 derives the presence or absence of a declaration based on the declaration information. The second derivation unit 58 derives the presence or absence of the detection of an accident history based on a change in acceleration according to the vehicle information, and the like. The second derivation unit 58 derives the presence or absence of the detection of a flood history or disregarded recall based on the maintenance information.

The evaluation on the engine includes, for example, the evaluation value of the target vehicle and the average evaluation value with regard to each of items such as torque, output, number of revolutions, response, quietness, fuel efficiency, and the like. The second derivation unit 58 derives the evaluation value of the target vehicle, based on various sensor values of the engine in the vehicle information and the like. The average evaluation value is included in the second information to be provided and indicates the average of the evaluation values of a plurality of vehicles of the same vehicle classification, the same model year, and the same travel distance classification as those of the assessment target vehicle. The evaluation on the engine can be also referred to as the degree of engine health.

The second server device 14 can relatively grasp the condition of the engine of the assessment target vehicle in comparison with the average of a plurality of vehicles of the same vehicle classification, the same model year, and the same travel distance classification as those of the assessment target vehicle, making it easy to calculate a more appropriate assessed value. The evaluation on the engine may include the evaluation value of a new vehicle of the same vehicle classification and the same model as those of the assessment target vehicle, and the evaluation value of the assessment target vehicle may be compared with the evaluation value of the new vehicle. Further, since the average evaluation value is the average of the respective evaluation values of a plurality of unspecified vehicles, the comparison can be made with a highly accurate average for those including vehicles that have not been distributed in the used car market in the past.

When the vehicle classification is a sports car, the number of items for the evaluation on the engine may be larger compared to when the vehicle classification is a light motor vehicle or the like. This is because more detailed evaluation on the engine makes it easy to calculate a more appropriate assessed value in this case. In a vehicle classification where the engine performance is relatively low, the evaluation on the engine may be represented by one evaluation value and may not be made separately for items. This is because detailed engine evaluation is unlikely to affect the assessed value in this case. This makes it easy to provide information that the assessor wants to know.

For the evaluation on the driving battery, the state of deterioration is indicated by a numerical value. The lower the numerical value is, the more the deterioration of the driving battery is in progress. The second derivation unit 58 derives the evaluation on the driving battery based on various sensor values and the like for the driving battery according to the vehicle information. The evaluation on the driving battery can be also referred to as the degree of health of the driving battery.

The fuel efficiency includes the fuel efficiency of the target vehicle, the average fuel efficiency, and the maximum fuel efficiency. The average fuel efficiency indicates the average fuel efficiency of a plurality of vehicles of the same vehicle classification and the same model year as those of the target vehicle. The maximum fuel efficiency indicates the highest value of fuel efficiency of a plurality of vehicles of the same vehicle classification and the same model year as those of the target vehicle. The second derivation unit 58 derives the fuel efficiency based on the fuel consumption per unit time, the odometer value, and the like according to the vehicle information.

The travel frequency indicates an average number of times of traveling per predetermined period such as one week. The single travel distance indicates the average travel distance in one travel. The second derivation unit 58 derives the travel frequency and the single travel distance based on the odometer value according to the vehicle information, the date and time information attached to the odometer value, and the like.

The driving tendency includes, for example, an evaluation value for each of items: “eco driving”; “safe driving”; and “driving with less load on the vehicle”. The evaluation value for “eco driving” decreases as the fuel efficiency becomes worse, and decreases as the period for which the eco mode is being selected becomes shorter. The evaluation value for “safe driving” decreases as the number of operations of safety equipment such as ABS increases. The evaluation value for “driving with less load on the vehicle” decreases as there are more rapid acceleration, quick steering, and quick braking. The second derivation unit 58 derives the driving tendency based on the vehicle information. Since the assessor can know how the assessment target vehicle has been driven in the past based on the driving tendency, the driving tendency is likely to be one of the valid judgment materials for determining the price.

Each item of the driving tendency may also include an average evaluation value for the same vehicle classification based on the history information of a plurality of vehicles. For example, in a sports car, the evaluation value of “eco driving” may be lower than that for other vehicle classifications. However, comparison to the average evaluation value of “eco driving” for the same vehicle classification is likely to be an effective judgment material for determining the assessed value. The average evaluation value for each item of the driving tendency is also included in the second information to be provided.

The warning lamp lighting history includes the date for lighting, the reason for lighting, a type, and a lighting-out history and can be also referred to as a failure history. The second derivation unit 58 derives the warning lamp lighting history based on the vehicle diagnostic information. The warning lamp lighting history allows an assessed value based on the past failure state to be easily calculated.

The maintenance history includes information indicating whether the owner at the time of the maintenance is the first owner, the second owner, the third owner, . . . , or the nth owner, the attribute of the owner, the date of the maintenance, the type of the maintenance, the details of the maintenance, the travel distance at the time of the maintenance, and information of the maintenance person. The second derivation unit 58 derives the maintenance history based on the maintenance information. Based on maintenance history, an assessed value based on whether or not the assessment target vehicle has been properly maintained can be easily calculated.

Although not shown, the vehicle record may include information on the presence or absence of optional vehicle equipment.

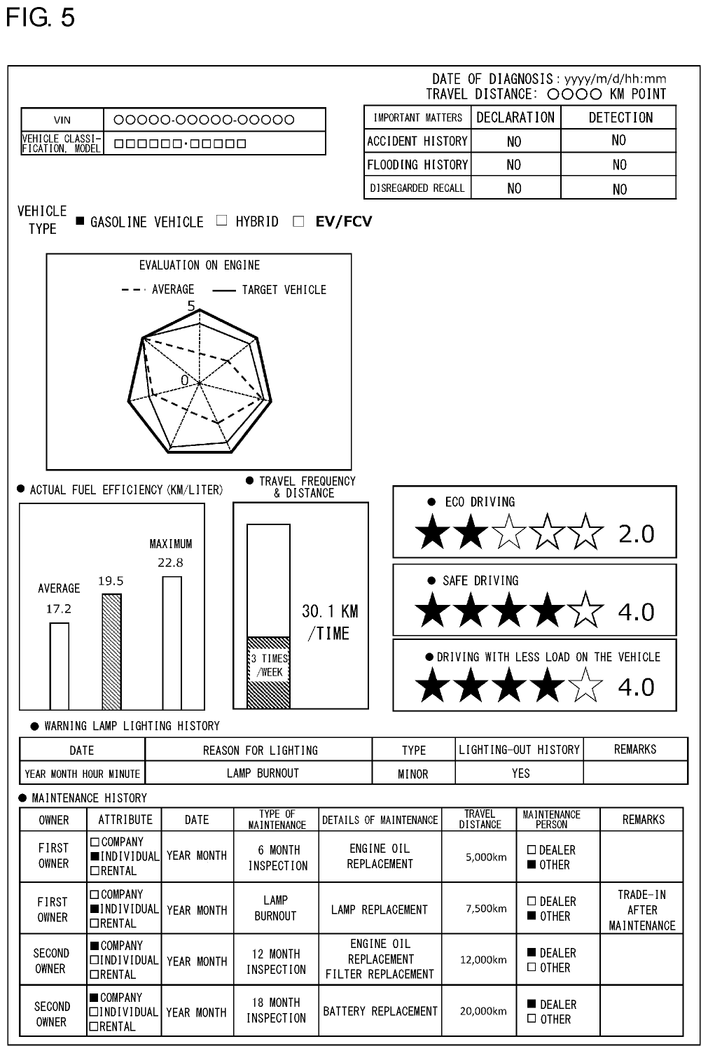

FIG. 5 shows a display example of a vehicle record of a vehicle whose vehicle type is a gasoline vehicle that is generated by the first server device 10 of FIG. 1.

This vehicle record is different from the vehicle record of FIG. 4 in that the vehicle record does not include the evaluation on the driving battery. The vehicle record may include the evaluation on a lead battery used for engine ignition and the like.

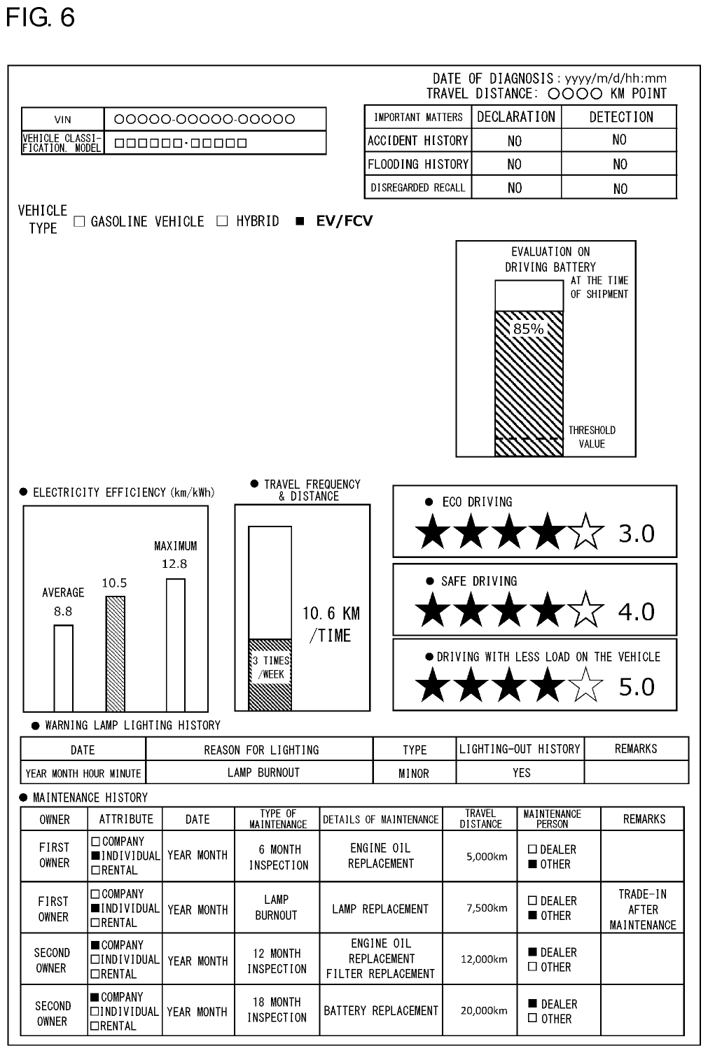

FIG. 6 shows a display example of a vehicle record of a vehicle whose vehicle type is an electric vehicle (EV) or fuel cell vehicle (FCV) that is generated by the first server device 10 of FIG. 1. This vehicle record is different from the vehicle record of FIG. 4 in that the vehicle record does not include the evaluation on the engine and includes the electricity efficiency instead of the fuel efficiency. The electricity efficiency represents the travel distance per unit electric energy.

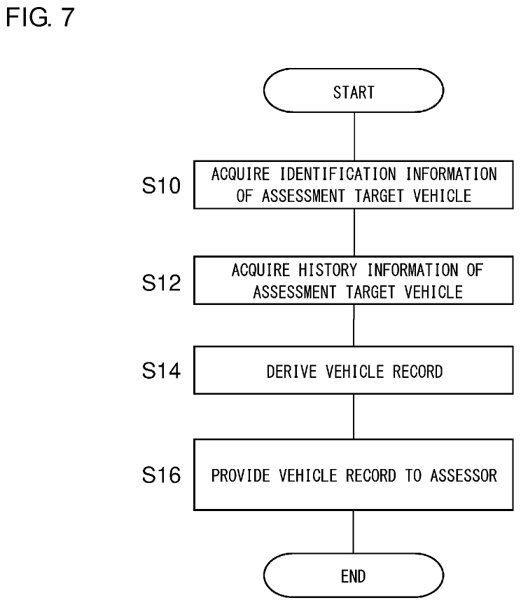

The overall operation of the first server device 10 having the above features will be described next. FIG. 7 is a flowchart showing the process of the first server device 10 of FIG. 1. The process in FIG. 7 is performed every time the second server device 14 of the assessor provides the identification information of the assessment target vehicle. The first server device 10 acquires the identification information of the assessment target vehicle from the assessor (S10) and acquires the history information of the assessment target vehicle based on the acquired identification information (S12). The first server device 10 derives the vehicle record based on the acquired history information (S14) and provides the derived vehicle record to the assessor (S16).

According to the present embodiment, the second server device 14 can derive, based on the first information to be provided based on the history information of the assessment target vehicle and the second information to be provided based on the statistical information regarding the vehicle classification of the assessment target vehicle, a more appropriate price for the assessment target vehicle. Therefore, the purchaser can obtain the more appropriate price for the assessment target vehicle.

### Second Embodiment

The second embodiment is different from the first embodiment in that the evaluation on the engine, the evaluation on the battery, and the like in the vehicle record are generated using the maintenance information as well. An explanation will be given in the following mainly regarding differences from the first embodiment.

For a part or oil for which replacement time recommended by the automobile manufacturer is determined, based on replacement date and time information of the part or oil in the maintenance information of the assessment target vehicle and on the predetermined replacement time, the second derivation unit 58 derives the first information to be provided. The replacement time is set for each part or oil. The replacement time may be set for each vehicle classification. Examples of a part or oil whose replacement time is determined include an engine oil, an oil filter, a brake oil, a spark plug, a lead battery, and the like.

The replacement of an engine oil will be described as an example. The replacement time of the engine oil is, for example, every year or every 15,000 km of traveling, whichever comes first. In the second embodiment, the evaluation on the engine is represented by one evaluation value. The second derivation unit 58 does not lower the evaluation on the engine if the engine oil has been replaced by the replacement time. The second derivation unit 58 lowers the evaluation on the engine if the engine oil has not been replaced by the replacement time. As the number of times the engine oil was not replaced by the replacement time increases, the second derivation unit 58 may lower the evaluation on the engine on a large scale. This makes it possible to provide a vehicle record reflecting whether or not the part or oil for which recommended replacement time is determined has been replaced at an appropriate time.

Further, with regard to a predetermined part, the second derivation unit 58 derives the first information to be provided, based on the vehicle information obtained after the replacement date and time related to the part of the target vehicle that has been replaced. For example, a driving battery can be listed as the predetermined part.

When the driving battery has been replaced, the second derivation unit 58 derives the evaluation on the driving battery based on the vehicle information obtained after the replacement date and time related to the driving battery. This is because when the driving battery has been replaced, the vehicle information on a driving battery before the replacement is irrelevant to the evaluation of the driving battery after the replacement. This allows an accurate evaluation on the part that has been replaced to be provided.

According to the present embodiment, a highly accurate vehicle record reflecting the maintenance status of the vehicle can be provided.

### Third Embodiment

The third embodiment is different from the first embodiment in that the first server device 10 provides history information and the like obtained before the conversion into a vehicle record format. An explanation will be given in the following mainly regarding differences from the first embodiment.

The first derivation unit 56 periodically derives statistical information for each vehicle classification by performing a statistical process on vehicle information of a plurality of vehicles. The statistical information is derived for each item of the vehicle information. The statistical information may include, for example, an average value of the frequency of an brake operation amount that is equal to or more than a predetermined operation amount in the plurality of vehicles.

The second derivation unit 58 derives the first information to be provided including the history information of the assessment target vehicle without deriving the vehicle record and derives the second information to be provided including statistical information for the vehicle classification of the assessment target vehicle.

The second server device 14 of the assessor derives an assessed value based on the first information to be provided and the second information to be provided that have been provided from the first server device 10. For example, the second server device 14 may derive the driving tendency of the assessment target vehicle, the evaluation on the engine, and the like through a process similar to the process in the first server device 10 according to the first embodiment and derive the assessed value based thereon.

According to the present embodiment, it is possible to respond to an assessor that requires history information and the like obtained before the conversion into a vehicle record format.

### Fourth Embodiment

The fourth embodiment is different from the first embodiment in that the first server device 10 periodically provides the assessor with statistical information for each vehicle classification. An explanation will be given in the following mainly regarding differences from the first embodiment.

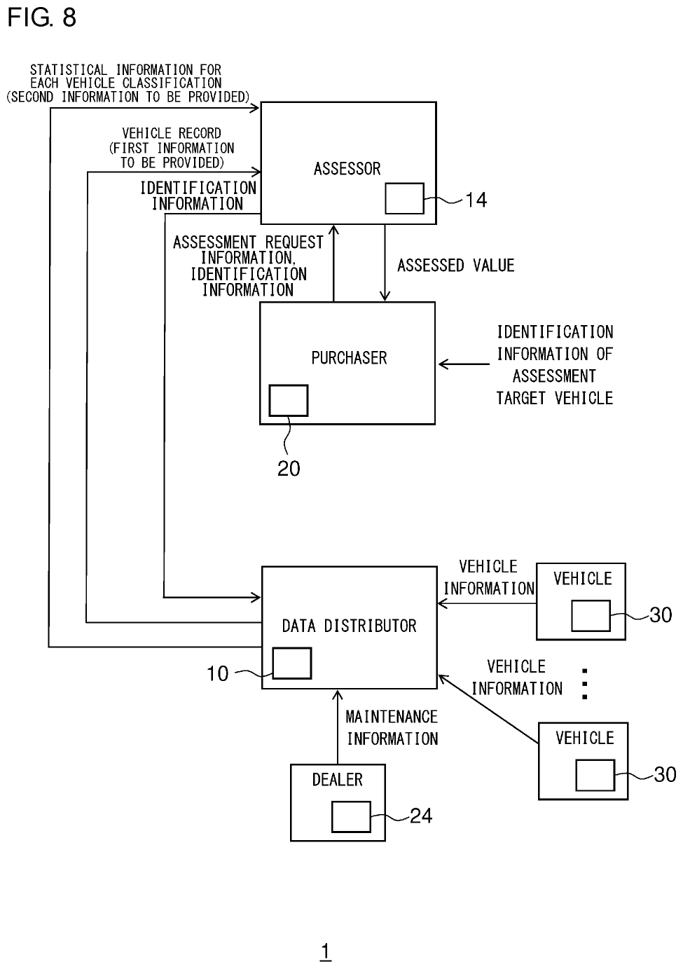

FIG. 8 shows the flow of data in an information processing system 1 according to the fourth embodiment. The provider 60 of the first server device 10 periodically provides the second server device 14 of the assessor with the second information to be provided that is based on statistical information for each vehicle classification in the history information of a plurality of vehicles. The second information to be provided includes statistical information for each vehicle classification as in the first embodiment. The frequency of providing the second information to be provided can be appropriately determined through an experiment or the like and may be, for example, once a month.

When the identification information is acquired by the first acquirer 50, the second derivation unit 58 derives the first information to be provided based on the identification information and the history information. In other words, the second derivation unit 58 derives the vehicle record of the assessment target vehicle that does not include the second information to be provided. The provider 60 provides the first information to be provided that has been derived by the second derivation unit 58 to the second server device 14 of the assessor.

The second server device 14 extracts statistical information of the vehicle classification of the assessment target vehicle from the second information to be provided based on the identification information and derives an assessed value based on the extracted statistical information and the first information to be provided.

According to the present embodiment, the degree of freedom of the configuration of the first server device 10 can be improved.

### Fifth Embodiment

The fifth embodiment is different from the fourth embodiment in that the first server device 10 provides history information and the like obtained before the conversion into a vehicle record format. An explanation will be given in the following mainly regarding differences from the fourth embodiment.

The first derivation unit 56 periodically derives statistical information for each vehicle classification as in the same way as in the third embodiment. The provider 60 periodically provides the second server device 14 of the assessor with second information to be provided including the statistical information for each vehicle classification.

When the identification information is acquired by the first acquirer 50, the second derivation unit 58 derives the first information to be provided including the history information of the assessment target vehicle, without deriving the vehicle record.

According to the present embodiment, it is possible to respond to an assessor that requires history information and the like obtained before the conversion into a vehicle record format.

### Sixth Embodiment

The sixth embodiment is different from the first embodiment in that the first server device 10 provides the vehicle record to the purchaser. An explanation will be given in the following mainly regarding differences from the first embodiment.

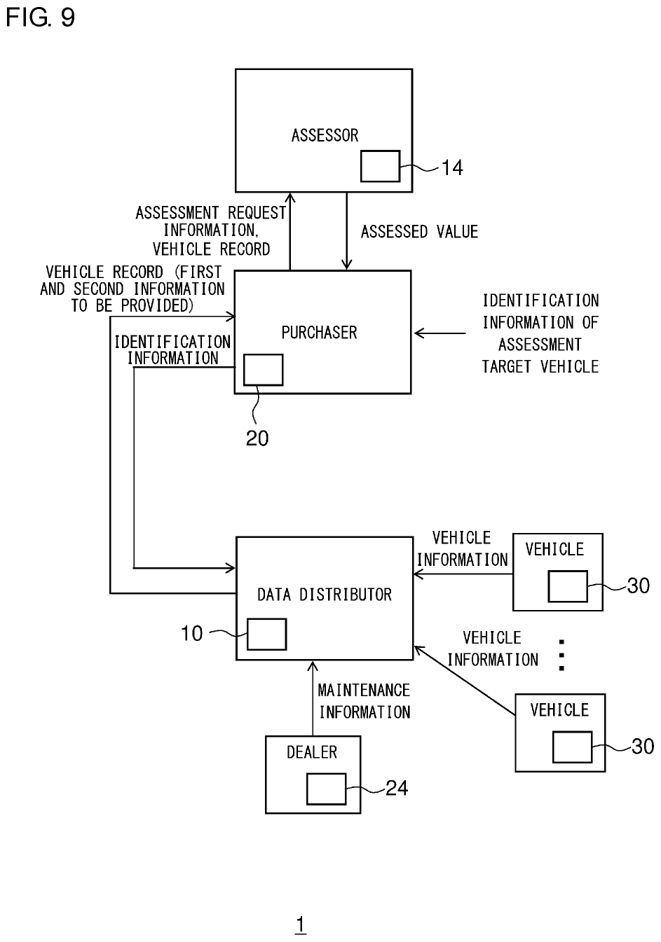

FIG. 9 shows the flow of data in the information processing system 1 according to the sixth embodiment. The first terminal device 20 of the purchaser transmits, to the first server device 10, the identification information of the assessment target vehicle that has been acquired from the vehicle owner.

In the first server device 10, as in the first embodiment, the second acquirer 52 acquires the history information and the like of the assessment target vehicle from the storage 44 based on the acquired identification information, and the second derivation unit 58 prepares a vehicle record of the assessment target vehicle based on the acquired historical information and the like. The provider 60 provides the first terminal device 20 with the vehicle record, that is, the first information to be provided and the second information to be provided that have been derived by the second derivation unit 58.

The first terminal device 20 of the purchaser deletes the identification information from the acquired vehicle record of the assessment target vehicle and transmits the vehicle record not including the identification information and the assessment request information to the second server device 14 of the assessor.

The second server device 14 of the assessor derives an assessed value based on the assessment request information and the vehicle record that have been acquired from the purchaser and provides the assessed value that has been derived to the first terminal device 20 of the purchaser.

According to the present embodiment, the purchaser acquires the vehicle record and provides the acquired vehicle record to the second server device 14 of the assessor so as to acquire the assessed value, and it is thus not necessary to provide identification information, which is personal information that allows for the identification of the vehicle, to the assessor.

### Seventh Embodiment

The seventh embodiment is different from the sixth embodiment in that the first server device 10 provides history information and the like obtained before the conversion into a vehicle record format. An explanation will be given in the following mainly regarding differences from the sixth embodiment.

The first derivation unit 56 derives statistical information for each vehicle classification as in the same way as in the third embodiment. The second derivation unit 58 derives the first information to be provided including the history information of the assessment target vehicle without deriving the vehicle record and derives the second information to be provided including statistical information for the vehicle classification of the assessment target vehicle.

The second server device 14 of the assessor derives an assessed value in the same way as in the third embodiment based on the first information to be provided and the second information to be provided that have been provided from the purchaser.

According to the present embodiment, it is possible to respond to an assessor that requires history information and the like obtained before the conversion into a vehicle record format.

### Eighth Embodiment

The eighth embodiment is different from the sixth embodiment in that the first server device 10 periodically provides the assessor with statistical information for each vehicle classification. An explanation will be given in the following mainly regarding differences from the sixth embodiment.

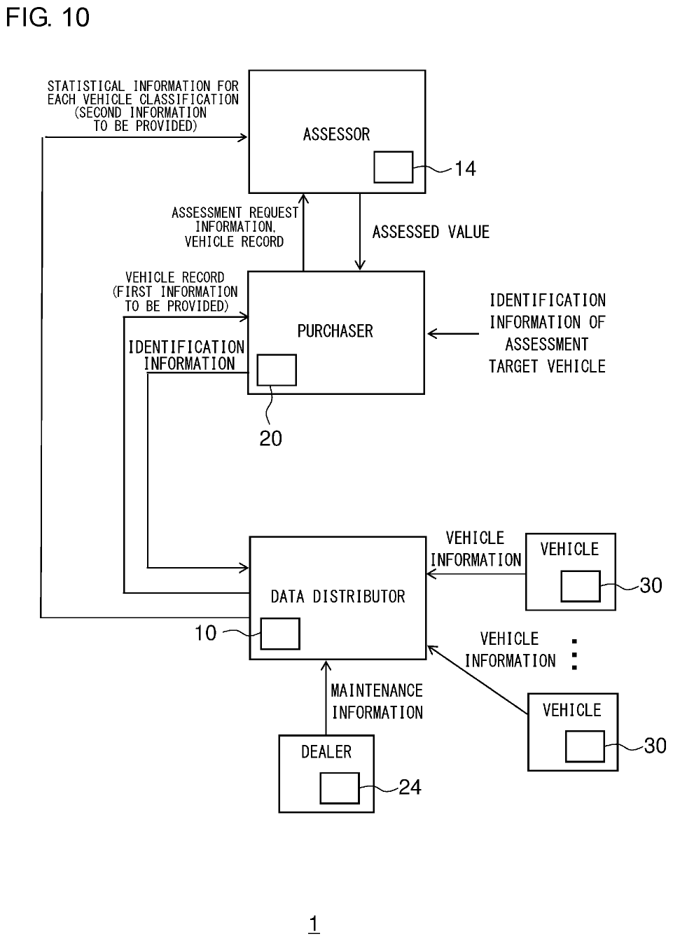

FIG. 10 shows the flow of data in the information processing system 1 according to the eighth embodiment. The provider 60 of the first server device 10 periodically provides the second server device 14 of the assessor with the second information to be provided including statistical information for each vehicle classification in the same way as in the fourth embodiment.

When the identification information is acquired by the first acquirer 50, the second derivation unit 58 derives the first information to be provided based on the identification information and the history information. The provider 60 provides the first information to be provided that has been derived by the second derivation unit 58 to the first terminal device 20 of the purchaser.

The second server device 14 extracts statistical information of the vehicle classification of the assessment target vehicle from the second information to be provided based on the identification information and derives an assessed value based on the extracted statistical information and the first information to be provided that has been provided from the purchaser.

According to the present embodiment, the degree of freedom of the configuration of the first server device 10 can be improved.

### Ninth Embodiment

The ninth embodiment is different from the eighth embodiment in that the first server device 10 provides history information and the like obtained before the conversion into a vehicle record format. An explanation will be given in the following mainly regarding differences from the eighth embodiment.

The first derivation unit 56 derives statistical information for each vehicle classification as in the same way as in the third embodiment. The provider 60 periodically provides the second server device 14 of the assessor with second information to be provided including the statistical information for each vehicle classification.

When the identification information is acquired by the first acquirer 50, the second derivation unit 58 derives the first information to be provided including the history information of the assessment target vehicle, without deriving the vehicle record.

According to the present embodiment, it is possible to respond to an assessor that requires history information and the like obtained before the conversion into a vehicle record format.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

The second embodiment may be combined with each of the third through ninth embodiments. New embodiments resulting from the combinations will provide the advantages of the embodiments that are combined.

In the embodiments, an example has been described in which the second derivation unit 58 derives the vehicle record based on the history information of the assessment target vehicle when the identification information of the assessment target vehicle is acquired. Alternatively, for each of the plurality of vehicles, the second derivation unit 58 may periodically derive a vehicle record based on the history information in advance. The second derivation unit 58 causes the storage 44 to store the derived vehicle record for each vehicle in association with the identification information. The second acquirer 52 acquires the vehicle record of the assessment target vehicle from the storage 44 based on the identification information of the assessment target vehicle that has been acquired by the first acquirer 50. The provider 60 provides the vehicle record acquired by the second acquirer 52. In this exemplary variation, the degree of freedom of the configuration of the first server device 10 can be improved.

In this exemplary variation, the provider 60 may provide the derived vehicle record to an in-vehicle device 30 of the vehicle or a portable terminal of the vehicle owner or the like every time the vehicle record is derived. This exemplary variation allows the vehicle owner to understand the current condition of the vehicle.

The second derivation unit 58 may derive the vehicle record without using the statistical information. In this exemplary variation, the process of the first server device 10 can be simplified and the amount of data to be stored can be reduced. Further, the first derivation unit 56 may derive statistical information on history information of a plurality of vehicles for each model.

What is claimed is:

1. A server device comprising:
a first acquirer configured to acquire identification information of a target vehicle;
a second acquirer configured to acquire vehicle information of the target vehicle including date and time information and maintenance information of the target vehicle including date and time information based on the identification information that has been acquired;
a derivation unit configured to derive information to be provided, based on the vehicle information and the maintenance information that have been acquired; and
a provider configured to provide the information to be provided that has been derived.

2. The server device according to claim 1, wherein
the maintenance information includes replacement date and time information of the part or oil, and
the derivation unit derives the information to be provided, based on the replacement date and time information and predetermined recommended replacement time.

3. The server device according to claim 1, wherein
the maintenance information includes replacement date and time information of a part, and
the derivation unit derives the information to be provided, based on vehicle information obtained after replacement date and time related to a replaced part of the target vehicle.

4. An information providing method comprising:
acquiring identification information of a target vehicle;
acquiring vehicle information of the target vehicle including date and time information and maintenance information of the target vehicle including date and time information based on the identification information that has been acquired in the acquiring of the identification information;
deriving information to be provided, based on the vehicle information and the maintenance information that have been acquired in the acquiring of the vehicle information and the maintenance information; and
providing the information to be provided that has been derived in the deriving.
